(19) United States
(12) Patent Application Publication
(10) Pub. No.: US 2010/0071052 A1
(43) Pub. Date: Mar. 18, 2010

(54) REVERSE PROXY ARCHITECTURE

(75) Inventors: Ziqing Mao, West Lafayette, IN (US); Cormac E. Herley, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/326,888

(22) Filed: Dec. 3, 2008

Related U.S. Application Data
(60) Provisional application No. 61/096,783, filed on Sep. 13, 2008.

(51) Int. Cl. H04L 9/32

(52) U.S. Cl. 726/12

(57) ABSTRACT

Aspects of the subject matter described herein relate to a reverse proxy architecture. In aspects, a client that seeks to access a Web document via a proxy sends a request to the reverse proxy. The reverse proxy obtains the Web document from a server indicated by the request and modifies links therein so that if the links are clicked on or otherwise fetched by the client, the communication goes back to the reverse proxy. The reverse proxy may also modify cookies, if needed, so that the cookies refer to a domain or hostname associated with the reverse proxy.

### CROSS REFERENCE TO RELATED APPLICATION

This application claims the benefit of U.S. Provisional Application No. 61/096,783, filed Sep. 13, 2008, entitled REVERSE PROXY ARCHITECTURE, which application is incorporated herein in its entirety.

### BACKGROUND

Logically, a reverse proxy stands between a browser and a server. A message sent from the browser to the server is received by the proxy. The proxy may then send a message to the server on the browser's behalf and receives a response thereto. The proxy sends a message corresponding to the response to the browser.

In contrast to HTTP proxies, where the browser is configured to send traffic through the proxy, a reverse proxy may be established without any such configuration to the browser.

To maintain its role as a reverse proxy, the reverse proxy needs to see communications between a browser and a server. This is a challenge as a Web document may include links to other documents that, if clicked on or otherwise fetched, may cause a communication outside of the reverse proxy.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to a reverse proxy architecture. In aspects, a client that seeks to access a Web document via a proxy sends a request to the reverse proxy. The reverse proxy obtains the Web document from a server indicated by the request and modifies links therein so that if the links are clicked on or otherwise fetched by the client, the communication goes back to the reverse proxy. The reverse proxy may also modify cookies, if needed, so that the cookies refer to a domain or hostname associated with the reverse proxy.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram representing another exemplary environment in which aspects of the subject matter described herein may be implemented;

FIG. 4 is a block diagram that represents an apparatus configured as a reverse proxy in accordance with aspects of the subject matter described herein;

FIG. 5 is a flow diagram that generally represents actions that may occur from a reverse proxy point of view in accordance with aspects of the subject matter described herein; and

FIG. 6 is a flow diagram that generally represents actions that may occur from a Web browser perspective in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. Other definitions, explicit and implicit, may be included below.

### Exemplary Operating Environment

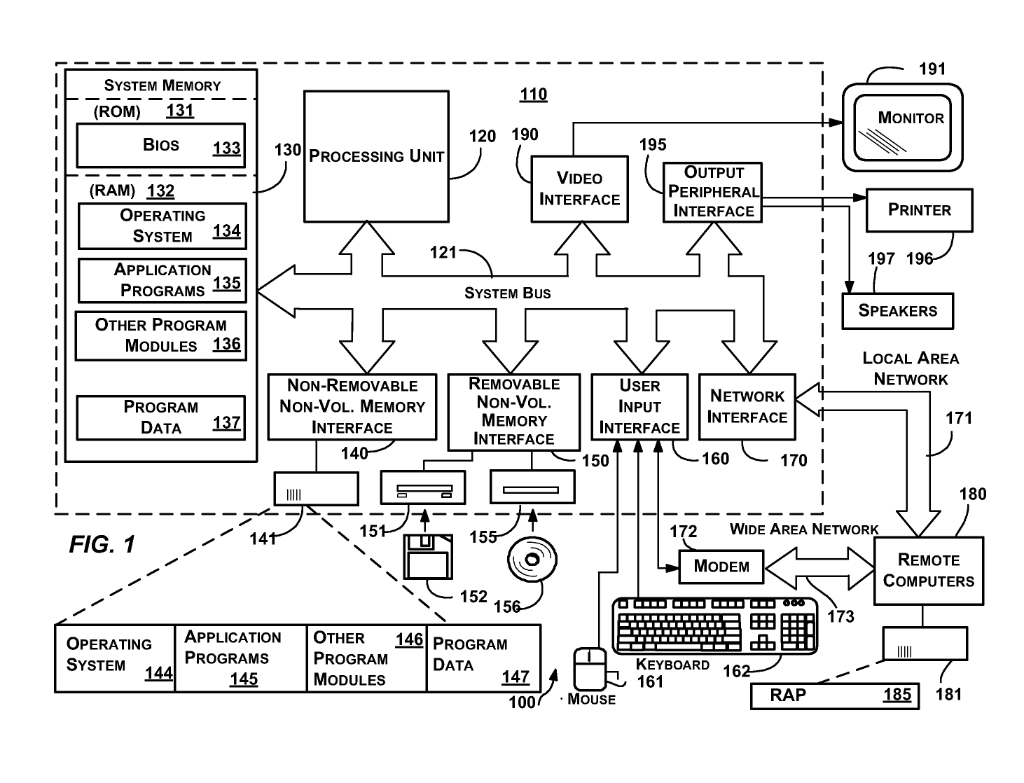

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Reverse Proxy

As mentioned previously, to maintain its role as a reverse proxy, the reverse proxy needs to see communications between a browser and a server. This can be a challenge as a Web document may include links to other documents that, if clicked on or otherwise fetched, may cause a communication directly to the server (and thus not passing through the reverse proxy).

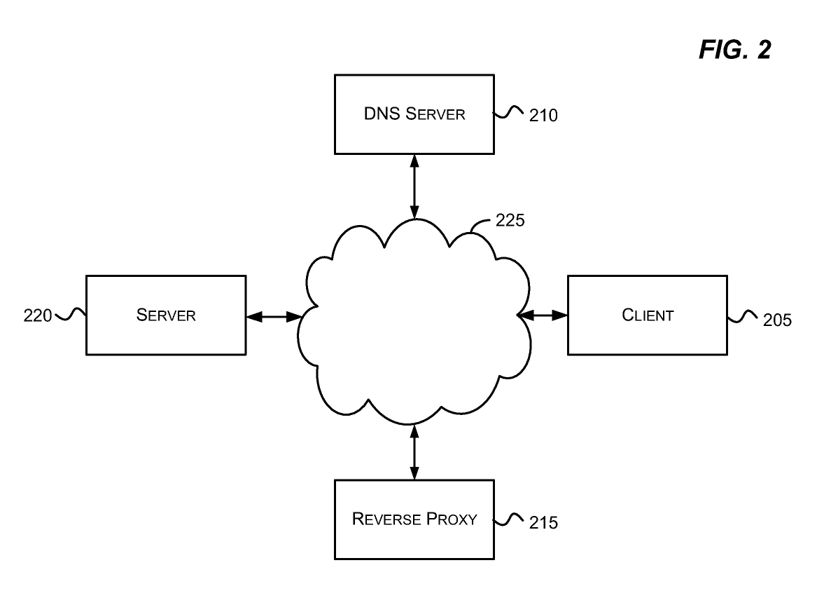

FIG. 2 is a block diagram representing an exemplary environment in which aspects of the subject matter described herein may be implemented. The environment includes a client 205, a DNS server 210, a reverse proxy 215, a server 220, a network 225, and may also include other entities (not shown).

The various entities may be located relatively close to each other or may be distributed across the world. The various entities may communicate with each other via various networks including intra- and inter-office networks and the network 225.

In an embodiment, the network 225 may comprise the Internet. In an embodiment, the network 225 may comprise one or more local area networks, wide area networks, wireless networks, direct connections, virtual connections, private networks, virtual private networks, some combination of the above, and the like.

The client 205, DNS server 210, reverse proxy 215, and server 220 may comprise or reside on one or more general or special purpose computing devices. Such devices may include, for example, personal computers, server computers, hand-held or laptop devices, multiprocessor systems, microcontroller-based systems, set top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as one or more entities indicated in FIG. 2 comprises the computer 110 of FIG. 1.

Although the terms “client” and “server” are used, it is to be understood, that a client may be implemented on a machine that has hardware and/or software that is typically associated with a server and that likewise, a server may be implemented on a machine that has hardware and/or software that is typically associated with a desktop, personal, or mobile computer. Furthermore, a client may at times act as a server and vice versa. In an embodiment, the client 205 and the server 220 may both be peers, servers, or clients. In one embodiment, the client 205 and the server 220 may be implemented on the same physical machine.

As used herein, each of the terms “server” and “client” may refer to one or more physical entities, one or more processes executing on one or more physical entities, and the like. Thus, a server may include an actual physical node upon which one or more processes execute, a service executing on one or more physical nodes, or a group of nodes that together provide a service. A service may include one or more processes executing on one or more physical entities.

In accordance with aspects of the subject matter described herein, the reverse proxy 215 may be implemented on a computer (e.g., the computer 110 of FIG. 1). Through domain name registration, the reverse proxy 215 may be registered to receive messages sent to the hostname of *.SLD.FLD, where “*” stands for any host string valid under the HTTP protocol, FLD stands for a first level domain, and SLD stands for a second level domain. Sometimes the first level domain may be referred to as a top level domain while the second level domain, third level domain, fourth level domain, and so forth may be referred to as subdomains.

For simplicity of explanation, the second level domain associated with a proxy as used herein will often be referred to as “proxy” while the first level domain used herein will often be referred to as “com”. It is to be understood, however, that these domains are exemplary and are not intended to be all-inclusive or restrictive as to the domains that may be used. Indeed, based on the teaching herein, virtually any domain name may be registered and used in conjunction with a reverse proxy without departing from the spirit or scope of aspects of the subject matter described herein. Equally, any first-level domain may be used in place of “com”.

A browser on the client 205 may utilize the reverse proxy 215 to obtain a Web page from the server 220 by encoding the hostname of the server 220 in the hostname of a URL. A URL may be defined with the following components:

<method>://<host>/<path>?<options>

For HTTP implementations, the method component is either “http” or “https.” The host component identifies a particular host that provides access to resources sometimes referred to as Web pages or Web documents. The path component identifies a particular resource on the host. The options specify parameters to pass to the host. An exemplary URL that identifies a particular resource is:

http://www.foo.com/Dir1/page1.html

To request this resource (e.g., a Web page) via the reverse proxy 215, the client 205 may encode a hostname (e.g., “www.foo.com”) associated with the server 220 in a hostname that refers to the proxy as follows:

http://www.foo.com.proxy.com/Dir1/page1.html

Notice that in this encoding the top level domain, “.com”, is replaced with “.com.proxy.com”. When the client 205 uses this URL to access the reverse proxy 215, the client 205 may utilize the DNS server 210. The DNS server 210 may look up an Internet Protocol (IP) address using the hostname (i.e., “www.foo.com.proxy.com”) and provide the IP address to the client 205. The reverse proxy 215 may also have registered as a wildcard host, so that, for example, any host of the form “*.proxy.com” returns the IP address of the reverse proxy. The client 205 may then cache this address for subsequent use and use the address to communicate with the reverse proxy 215.

When the reverse proxy 215 receives a request for the resource indicated by http://www.foo.com.proxy.com/Dir1/page1.html, the reverse proxy 215 may create another URL from this URL. To do this, the reverse proxy 215 may substitute “.com” for the “.com.proxy.com” portion of the received URL and use the new URL thus modified (e.g., http://www.foo.com/Dir1/page1.html) to obtain data from the server 220. In this request to the server 220, the reverse proxy 215 appears to the server 220 to be a client. In other words, the server 220 may not be aware that the data will ultimately be used by a browser on the client 205.

The server 220 may send data (e.g., a Web page) to the reverse proxy 215. The data may include links to other documents that, if followed or retrieved by the client 205, may cause a communication outside of the reverse proxy 215. Generally, links may be absolute or relative and may also be static or dynamic. For example, a static link may start with an “HREF=” followed by a relative or absolute address. As another example, a dynamic link may start with an “HREF=” followed by variables, text, or functions that evaluate into a relative or absolute address.

When the reverse proxy 215 receives data (e.g., a Web page) from the server 220, the reverse proxy 215 may scan the data for absolute links that are either static or dynamic. For each such link found, the reverse proxy 215 may transform the link into a link that will refer back to the reverse proxy 215. For example, if an absolute link refers to http://www.foo.com/Dir1/page2.html, the reverse proxy 215 may transform this into http://www.foo.com.proxy.com/Dir1/page2.html.

Likewise, if an absolute link is found in the form of a combination of variables, text, or functions, such as HREF=String1+String2+“.com”+“/”+PathFunction( ), the reverse proxy 215 may transform this into HREF=String1+String2+“.com.proxy.com”+“/”+PathFunction( ). Similarly, if in the data, the reverse proxy 215 finds a declaration of a variable that includes a top level domain, the reverse proxy 215 may modify the declaration to reference the reverse proxy 215. For example, in reading data returned by the server 220, the reverse proxy 215 may find the following exemplary code:

```
var x = “.com”;
function f( )
{
    var method = “http://”;
    var host = “www”;
    var dom = “foo”;
    var path = “/Dir1/page1.html”
    var href = method + host + “.” + dom +  + x + path;
    return href;
}
```

In response, the reverse proxy 215 may change this code as follows:

```
var x = “.com.proxy.com”;
function f( )
{
    var method = “http://”;
    var host = “www”;
    var dom = “foo”;
    var path = “/Dir1/page1.html”
    var href = method + host + “.” + dom +  + x + path;
    return href;
}
```

Certain exceptions are common enough to merit separate handling. For example, a string that is a top-level domain can also sometimes occur as a second level domain. For example, in the URL “http://www.foo.com.br”, the top-level domain “.br” may be replaced and not the second-level domain “.com” so that the transformed URL becomes “http://www.foo.com.br.proxy.com”. Equally, there may be times when the string “.com” (or another top-level domain) appears in a response but does not represent a link to be transformed. For example, a reference to “system.component” is not to be transformed.

The examples above of what the reverse proxy 215 may do to transform absolute links are not intended to be all-inclusive or exhaustive. Indeed, based on the teachings herein, those skilled in the art may recognize many other transformations that may be employed by the reverse proxy 215 to transform absolute links into proxy-referring links such that “clicking on” these links or otherwise retrieving data from the links will cause a communication to be sent to the reverse proxy 215.

Note that using the mechanism described above, the reverse proxy 215 does not need to translate relative links. When a browser on the client 205 interprets a relative link in a page returned by the reverse proxy 215, the browser will automatically refer back to the reverse proxy 215 for the relative link. This results, in part, because a relative link is a request for a document on the same server that returned the Web page. A relative link indicates a relative path to the document. For example, a relative link may be indicated by HREF=“../page2.html”. When a browser sees this instruction, the browser is aware that it is to use the same server but modify the path to obtain the requested document.

After the reverse proxy 215 has modified the absolute links in the document, the reverse proxy 215 may then forward the modified document to the browser on the client 205.

When the server 220 sends a cookie to be stored on the client 205, the reverse proxy 215 may change the cookie, if needed, so that the browser on the client 205 sends the cookie when sending a request to the server 220 via the reverse proxy 215.

Normally, a Web browser associates a cookie with a hostname of the server from which the Web browser received the cookie. When the Web browser requests information from the server, the Web browser sends the associated cookie, if any. For example, if a Web browser on the client 205 uses the URL http://www.foo.com.proxy.com/Dir1/page1.html to request a page from the server 220 via the reverse proxy 215, the server 220 may send a cookie to be stored on the client 205. Each time the Web browser on the client 205 sends a request using the hostname “www.foo.com.proxy.com”, the Web browser may send the cookie it received. In this case, the reverse proxy 215 does not need to make any modification to the cookie to get the Web browser on the client 205 to send the cookie when requesting a page from “www.foo.com.proxy.com”.

Sometimes, however, a server may send a cookie that indicates a domain. For example, the server 220 may send a cookie that indicates a domain of “.foo.com”. The Web browser is expected to send the cookie each time it communicates with a server that is a member of this domain. In this case, the reverse proxy may modify the domain indicated by the cookie so that it refers to the domain of the reverse proxy. For example, when the server 220 sends a cookie that indicates a domain of “.foo.com”, the reverse proxy may change this cookie to indicate a domain of “.foo.com.proxy.com”. Then, when a browser on the client attempts to communicate via the reverse proxy 215 with a server that is a member of “.foo.com”, the browser may automatically send the cookie to the reverse proxy 215. If the browser sends the domain when sending the cookie, the reverse proxy 215 may transform the domain from “.foo.com.proxy.com” to “.foo.com” before sending the cookie to the server 220.

The server 220 may send a certificate for various reasons as will be understood by those skilled in the art. Certificates may be handled in a variety of ways. For example, some browsers allow a wildcard certificate that covers *.proxy.com, where * stands for any valid hostname string. In this case, a certificate for *.proxy.com may be obtained from a certificate authority. The reverse proxy 215 may send this certificate to a browser on the client 205. Browsers that allow the wildcard certificate may be satisfied that they are connected to a server having a valid certificate, even though they are connected to the reverse proxy 215.

Some browsers support a certificate that includes a wildcard, but the wildcard can only match hostnames in one subdomain not multiple subdomains. For example, a wildcard certificate with *.proxy.com may match hosts with names www.proxy.com, foo.proxy.com, anyothername.proxy.com, but may not match hosts with names a.b.proxy.com or a.b.c.proxy.com. In this case, for some browsers, sending such a certificate may only work for hostnames having one or relatively few subdomains.

As another example, certificates may be handled by registering a certificate for each expected hostname. For example, certificates may be obtained for www.a.com.proxy.com, www.b.com.proxy.com, www.c.com.proxy.com, and so forth. When a browser on the client 205 sends a request to the reverse proxy 215 for www.a.com.proxy.com, the reverse proxy 215 may respond with a certificate associated with www.a.com.proxy.com.

As another example, the browser on the client 205 may be configured or programmed to trust all certificates sent by the reverse proxy 215. As yet another example, the reverse proxy 215 may be configured as an intermediate certificate authority. In this example, the reverse proxy 215 may generate certificates on demand to give to the browser on the client 205.

As yet another example, the reverse proxy 215 may simply generate its own certificates without having these certificates registered with a commonly-trusted certificate authority. When a browser on the client 205 receives such a certificate, it may ask the user whether the user trusts such a certificate.

The reverse proxy 215 may be configured such that communications from the client 205 to the reverse proxy 215 are encrypted even if the server 220 does not encrypt the communications. For example, while the server 220 might not use SSL (and thus serve requests of the form http://www.foo.com) the user might nonetheless wish to have communications between the browser and the proxy encrypted. In this embodiment, the reverse proxy 215 may be configured to change instances of “http” to “https” in a Web page before sending the response to the browser on the client 205.

When a link in a response from the server 220 already includes “https”, the reverse proxy 215 may add a “secure.” before the hostname of a link. For example, if the server 220 sends data that includes a link such as https://www.foo.com/Dir1/page1.html, the reverse proxy 215 may transform this link into https://secure.www.foo.com.proxy.com/Dir1/page1.html. If the user subsequently clicks on this link and a request is sent to the reverse proxy 215, the reverse proxy 215 may remove the “secure.” as well as change the “.com.proxy.com” to “.com”. Then the reverse proxy 215 may open a secure channel to the server 220 using the modified URL.

Although the string “secure.” is mentioned above, in other embodiments, virtually any string may be used without departing from the spirit or scope of aspects of the subject matter described herein.

Also, although the examples above show a transformation of a link from *.com to *.com.proxy.com, in another embodiment the transformation may be performed by adding one or more domains as the end of a hostname. For example, if the server 220 sends data that includes a link such as http://www.foo.co.uk/Dir1/page1.html, the reverse proxy 215 may transform this link into http://www.foo.co.uk.proxy.com/Dir1/page1.html.

Furthermore, more than one subdomain may be used in transforming a link. For example, if the server 220 sends data that includes a link such as http://www.foo.com/Dir1/page1.html, the reverse proxy 215 may transform this link into http://www.foo.com.a.b.proxy.com/Dir1/page1.html.

In operating as described above, the reverse proxy 215 ensures that it remains in the communication path between a browser on the client 205 and servers to which the browser may link from a returned page. This allows many interesting applications including, for example, caching a history of Web pages visited, possibly even from browsers on different machines used by a user.

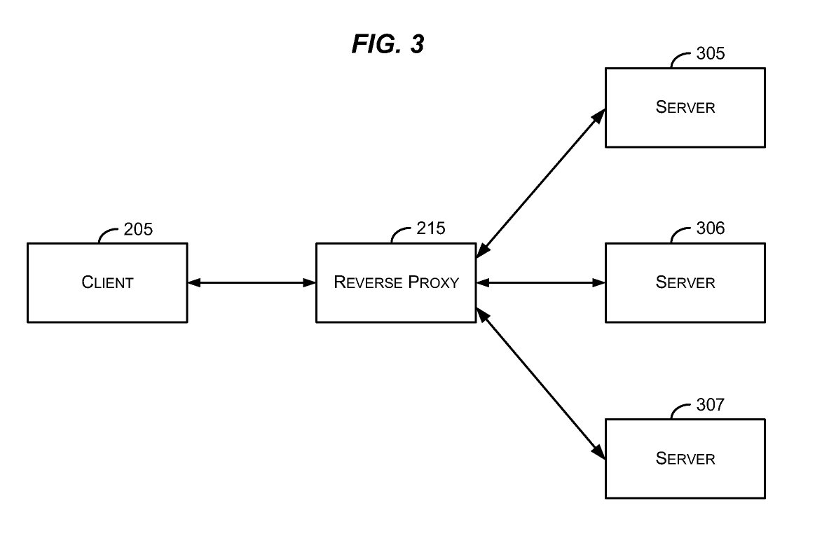

FIG. 3 is a block diagram representing another exemplary environment in which aspects of the subject matter described herein may be implemented. As illustrated in FIG. 3, the environment includes a client 205, a reverse proxy 215, and servers 305-307. The client 205, reverse proxy 215, and servers 305-307 may be implemented as described previously in conjunction with FIG. 2. When the client 205 obtains a Web page from one of the servers 305-307, this Web page may include links that refer to others of the servers 305-307. By transforming links in Web pages provided by the servers 305-307, the reverse proxy 215 is able to keep itself in the communication path between the client 205 and any servers linked to via returned Web pages.

Although the environments described above in conjunction with FIGS. 2-3 include various numbers of each of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

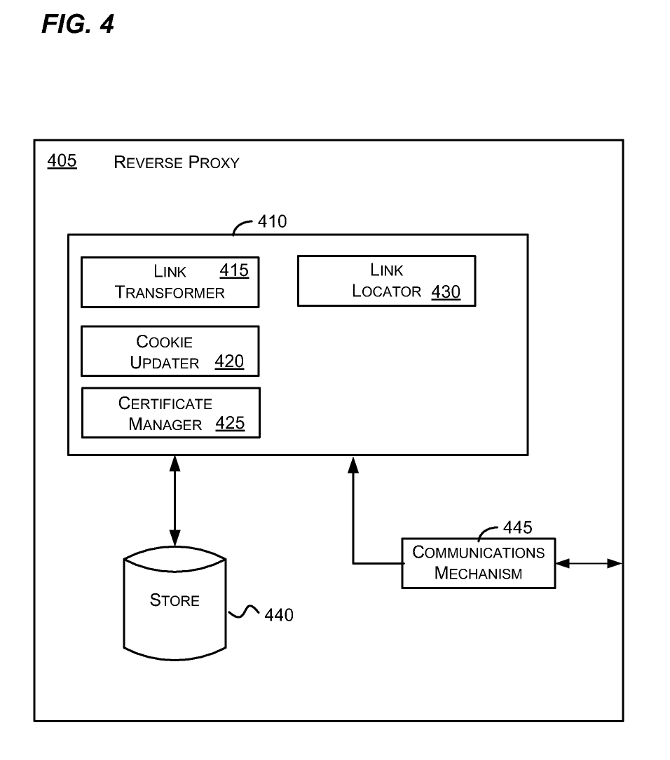

FIG. 4 is a block diagram that represents an apparatus configured as a reverse proxy in accordance with aspects of the subject matter described herein. The components illustrated in FIG. 4 are exemplary and are not meant to be all-inclusive of components that may be needed or included. In other embodiments, the components and/or functions described in conjunction with FIG. 4 may be included in other components (shown or not shown) or placed in subcomponents without departing from the spirit or scope of aspects of the subject matter described herein. In some embodiments, the components and/or functions described in conjunction with FIG. 4 may be distributed across multiple devices.

Turning to FIG. 4, the apparatus 405 (sometimes referred to as the reverse proxy 405) may include link components 410, a store 440, and a communications mechanism 445. The link components 410 may include a link transformer 415, a cookie updater 420, a certificate manager 425, and a link locator 430.

The communications mechanism 445 allows the apparatus 405 to communicate with other entities shown in FIG. 2. The communications mechanism 445 may be a network interface or adapter 170, modem 172, or any other mechanism for establishing communications as described in conjunction with FIG. 1. In operation, the communications mechanism 445 may receive a request from a Web browser. The request may include an indication of a server from which to obtain the document. This indication may be encoded in the hostname of the proxy as indicated in a URL sent to the reverse proxy 405. Using this indication, the communications mechanism 445 may communicate with the server to obtain the document.

The store 440 is any storage media capable of storing data. The term data is to be read to include information, program code, program state, program data, Web data, other data, and the like. The store 440 may comprise a file system, database, volatile memory such as RAM, other storage, some combination of the above, and the like and may be distributed across multiple devices. The term document is to be read to include data. The store 440 may be external, internal, or include components that are both internal and external to the apparatus 405.

The link transformer 415 is operable to use data associated with a first link in a document obtained from a server to create a second link. When the second link is evaluated (e.g., via a Web browser), the second link includes a hostname that refers to the proxy and encodes a server from which data corresponding to the link may be obtained. The link transformer is operable to transform both absolute and dynamic links received in a Web page from a server into a form suitable to keep the reverse proxy 405 in the communication path between the Web browser and hosts indicated in the Web page.

The cookie updater 420 is operable to determine whether a cookie refers to a server and needs to be modified before sending the cookie to a Web browser. If the cookie needs to be modified, the cookie updater 420 is further operable to update the cookie to refer to the proxy instead of the server in a manner described previously.

The certificate manager 425 is operable to provide certificates to a requester (e.g., Web browser) communicating with the reverse proxy 405. The certificate is usable by the requester to verify that the requester is sending the request to the proxy. The certificate manager 425 may use one or more of the techniques described previously in providing a certificate.

The link locator 430 is operable to scan document (e.g., a Web page) sent from a server for data associated with links and to identify or provide these links to the link transformer 415.

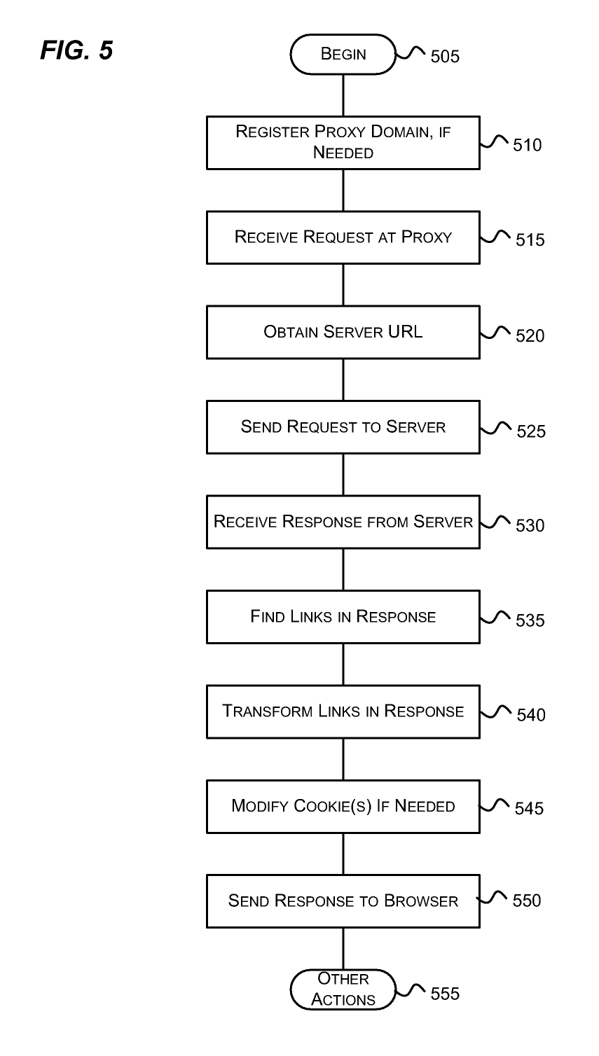

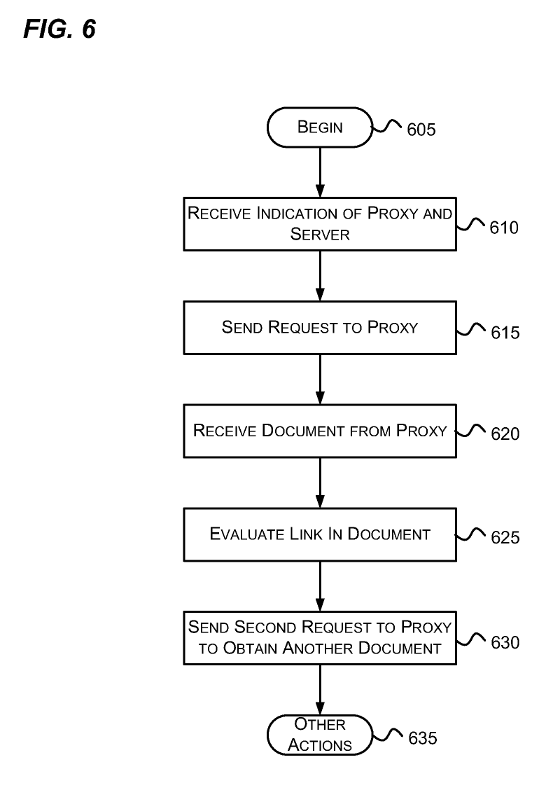

FIGS. 5-6 are flow diagrams that generally represent actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 5 is a flow diagram that generally represents actions that may occur from a reverse proxy point of view in accordance with aspects of the subject matter described herein. At block 505, the actions begin.

At block 510, a domain of the proxy is registered with a domain name registrar if needed. For example, referring to FIG. 2, if the reverse proxy 215 is to be associated with *.proxy.com, this domain is registered with an appropriate domain name registrar, if needed.

At block 515, a request for a document is received at the proxy. The request includes an indication of a server from which to obtain the document. For example, referring to FIG. 2, a Web browser on the client 205 sends a request for http://www.foo.com.proxy.com/Dir1/page1.html to the reverse proxy 215. The request includes an indication (e.g., www.foo.com) of a server from which to obtain the document. This server corresponds to server 220.

At block 520, a server URL is obtained from the request. For example, the URL http://www.foo.com.proxy.com/Dir1/page1.html is translated to http://www.foo.com/Dir1/page1.html.

At block 525, the request is sent to the server to obtain the document. For example, referring to FIG. 2, the reverse proxy 215 sends a request to the server 220 using the URL http://www.foo.com/Dir1/page1.html.

At block 530, a response that includes the document is received from the server. For example, referring to FIG. 2, the reverse proxy 215 receives a response that includes the requested document from the server 220.

At block 535, the document is searched for data associated with links. For example, referring to FIG. 4, the link locator 430 searches the document for data associated with links. This data may include one or more of text, variables, and function names that evaluate to absolute links. For static links, “evaluation” may comprise determining that the text is an absolute static link.

At block 540, this data is used to create other links that, when evaluated (e.g., on a Web browser), point to the reverse proxy and encode hostnames in the hostname of the reverse proxy. For example, referring to FIG. 4, the link transformer 415 may transform http://www.foo.com/Dir1/page1.html to http://www.foo.com.proxy.com/Dir1/page1.html.

At block 545, cookies are changed as needed. For example, referring to FIG. 4, the cookie updater 420 may update a cookie that indicates a domain so that the domain points to the reverse proxy 405.

At block 550, a response is sent to the browser. For example, referring to FIG. 2, the reverse proxy 215 sends a document to the client 205. In this document, links have been updated to refer the client back to the reverse proxy 215.

At block 555, other actions, if any may occur.

FIG. 6 is a flow diagram that generally represents actions that may occur from a Web browser perspective in accordance with aspects of the subject matter described herein. At block 605, the actions begin.

At block 610, an indication of a proxy and a server from which to obtain a document via the proxy is received. For example, referring to FIG. 3, a Web browser on the client 205 receives an indication (e.g., via a URL text input element) from a user of the reverse proxy 215 and the server 306. For example, a user may enter http://www.foo.com.proxy.com/Dir1/page1.html into the URL text input element.

At block 615, the request is sent to the proxy. For example, referring to FIG. 3, when the user clicks “go” or otherwise indicates that the browser is to obtain the document indicated by the URL, the client 205 sends a request to the reverse proxy 215. The document is likely to have links that refer to other servers. These links are fixed by the reverse proxy 215 as previously mentioned.

At block 620, a document is received from the proxy. For example, referring to FIG. 3, the client receives a document from the reverse proxy 215. The document includes a link that has been created by the proxy using data corresponding to a link found in a document returned by the server 306. The created link, when evaluated, includes a hostname that refers to the reverse proxy 315 and encodes the hostname of the server 305.

At block 625, a link in the document is evaluated. For example, referring to FIG. 3, when the browser on the client 205 loads the document returned by the reverse proxy 215, a link may evaluate to an address of an image that is to be retrieved from the server 305 via the reverse proxy 215.

At block 630, another request is sent to the proxy to obtain another document referred to by the link. For example, referring to FIG. 3, the client 205 sends a request to the reverse proxy 215 to obtain an image from the server 305.

At block 635, other actions, if any, are performed.

The reverse proxy architecture described above may be used in many different applications. As the proxy stands between a client and a server or a multitude of servers, the proxy can relay traffic or it may facilitate or perform custom modifications to the traffic to add functionality.

In one embodiment, a proxy performs various content adaptation and filtering functions. For example, a proxy may remove links to certain sites known to track user behavior. As another example, a proxy may maintain a blacklist of sites known to host malware, adult content, or other material forbidden by policy and either warn the user before fetching the content, terminate the connection, or perform other actions.

In another embodiment, a proxy may be personalized for a particular user and add useful functions. For example, a user may direct traffic to the proxy from each client the user uses so that the proxy serves as an intermediary no matter what machine or browser the user uses and no matter what the location. The proxy may archive all traffic sent through the proxy and provide a facility to allow the user to later search the user's browsing history. As another example, the proxy may automatically fill certain form fields in pages as they are fetched, thereby sparing the user the effort of typing data such as name and address at different sites. As another example, the proxy may provide any of the functionality generally provided in a browser plug-in or add-on thereby making the functionality available no matter what machine the user uses.

In another embodiment, the proxy may be used to add functionality to a Web server without changing the server itself. For example, the proxy may be dedicated to one or more servers. Rather than change existing server functionality, changes may be implemented at the proxy, thus allowing users who address the legacy server via the proxy to see the enhanced functionality. For example, certain POST events could be forbidden in certain circumstances.

The embodiments and examples provided above are not intended to be all-inclusive or exhaustive. Indeed, based on the teachings herein, those skilled in the art may recognize many other uses of a proxy that may be implemented without departing from the spirit or scope of aspects of the subject matter described herein.

As can be seen from the foregoing detailed description, aspects have been described related to a reverse proxy architecture. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving, at a proxy, a request for a document, the request including an indication of a server from which to obtain the document;
obtaining the document from the server;
searching through the document for a data associated with a first link, the first link including a first hostname; and
using the data to create a second link, the second link, when evaluated, including a second hostname, the second hostname encoding the first hostname therein, the second hostname referring to the proxy.

2. The method of claim 1, wherein the indication comprises a hostname of the server encoded in a hostname of the proxy.

3. The method of claim 1, wherein the request comprises an HTTP request.

4. The method of claim 1, wherein the document comprises a Web page.

5. The method of claim 1, wherein the first link comprises an absolute link and wherein using the data to create a second link comprises changing the absolute link to encode the first hostname in the second hostname.

6. The method of claim 1, wherein the first link comprises a dynamic link and wherein using the data to create a second link comprises changing a variable declaration associated with the dynamic link, the variable declaration used to form the first hostname, changing the variable declaration causing the second hostname to be generated when the dynamic link is evaluated.

7. The method of claim 1, wherein the first link comprises a dynamic link and wherein using the data to create a second link comprises changing a string associated with the dynamic link, the string used to form the first hostname, changing the string causing the second hostname to be generated when the dynamic link is evaluated.

8. The method of claim 1, further comprising sending to a Web browser of a client a document that when evaluated by the Web browser creates the second link instead of the first link of the document obtained from the server.

9. The method of claim 1, further comprising changing a cookie received from the server to refer to the proxy and sending the cookie to a Web browser of a client.

10. The method of claim 1, wherein receiving, at a proxy, a request for a document comprises receiving an encrypted request for the document from a Web browser and wherein obtaining the document from the server comprising obtaining the document from the server without encryption.

11. The method of claim 1, further comprising obtaining a hostname of the server from a hostname used to send the request to the proxy.

12. The method of claim 1, wherein using the data to create a second link comprises encoding in the second hostname whether the first link indicates that a secure channel is to be used to obtain data available via the first link.

13. In a computing environment, an apparatus, comprising:
a communications mechanism operable to receive a request for a document, the request including an indication of a server from which to obtain the document, the communications mechanism further operable to communicate with the server to obtain the document;
a link locator operable to scan the document for data associated with a first link, the first link including a first hostname; and
a link transformer operable to use the data to create a second link that, when evaluated, includes a second hostname, the second hostname encoding the first hostname therein, the second hostname referring to the proxy.

14. The apparatus of claim 13, further comprising a cookie updater operable to determine whether a cookie refers to the server and, if so, to update the cookie to refer to the proxy instead of the server.

15. The apparatus of claim 13, further comprising a certificate manager operable to provide a certificate to a requester sending the request, the certificate usable to verify that the requester is sending the request to the proxy.

16. The apparatus of claim 13, wherein the link transformer is operable to use the data to create a second link by appending a domain associated with the proxy to the first hostname.

17. A computer storage medium having computer-executable instructions, which when executed perform actions, comprising:
receiving an indication of a proxy and a first server from which to obtain a first document via the proxy;
sending a request to the proxy to obtain the first document from the first server, the first document having a first link that refers to a second server; and
receiving a second document from the proxy, the second document including a second link that has been created by the proxy using data corresponding to the first link, the second link, when evaluated, including a first hostname that refers to the proxy, the first hostname encoding a second hostname that refers to the second server.

18. The computer storage medium of claim 17, wherein receiving an indication of a proxy and a first server from which to obtain a first document via the proxy comprises receiving, at a Web browser, a hostname of the proxy that encodes a hostname of the first server therein.

19. The computer storage medium of claim 17, further comprising evaluating the second link and sending a request for a third document to the proxy, the request for the third document including the second link, as evaluated.

20. The computer storage medium of claim 17, wherein the second link comprises one or more of text, a function name, and a variable name.
